(19) United States
(12) Patent Application Publication
(10) Pub. No.: US 2004/0199789 A1
(43) Pub. Date: Oct. 7, 2004

(54) Anonymizer data collection device

(76) Inventors: Terry D. Shaw, Broomfield, CO (US); Simon L. Krauss, Denver, CO (US)

Correspondence Address: PATTON BOGGS, 1660 LINCOLN ST, SUITE 2050, DENVER, CO, 80264, US

(21) Appl. No.: 10/334,447

(22) Filed: Dec. 30, 2002

(51) Int. Cl. H04L 9/00; G06F 15/16

(52) U.S. Cl. 713/201; 709/223; 713/150

(57) ABSTRACT

The present anonymizer data collection device includes a suitable encryption process for encrypting a permanent identifier assigned to the subscriber or the subscriber equipment to produce an encrypted identifier. Information relating to the subscriber's data use of the network is collected and tagged with the encrypted identifier to protect the identity of the individuals from which the data are collected.

### FIELD OF THE INVENTION

This invention relates to digital communication and more specifically, to protecting the identification of the individual subscriber of collected subscriber data use information.

### PROBLEM

It is a problem in the field of digital communication to protect the identification of an individual subscriber while also allowing the network operator to track and record subscriber variables related to the subscriber's use of the operator's network. Network operator's provide a network for handling incoming and outgoing data signals between the network operator and a subscriber's personal or business computer or television set. A cable network operator provides a cable network between the subscriber equipment and a termination system, referred to as a Cable Modem Termination System (CMTS).

A CMTS is a system of devices that allows cable television operators to offer high-speed Internet access to home computers. The CMTS sends and receives digital cable modem signals on a cable network, receiving signals sent upstream from a subscriber's cable modem, converting the signals to IP packets and routing the signals on to an Internet Service Provider (ISP) for connection to the Internet. The CMTS also sends signals downstream from the Internet to the user's cable modem. Cable modems cannot communicate directly with each other; they must communicate by channeling their signals through the CMTS.

DOCSIS (Data Over Cable Service Interface Specification) has become a standard interface for cable modems, the devices that handle incoming and outgoing data signals between the cable operator and a subscriber's personal or business computer or television set. DOCSIS specifies modulation schemes and the protocol for exchanging the bi-directional signals over cable. In other words, DOCSIS is the protocol used for sending and receiving signals between the subscriber cable modem and the CMTS where the signals are converted to/from DOCSIS from/to IP packets.

In a DOCSIS-based cable data system, data on individual subscriber's data use may be collected by various means and uniquely identified by tagging the data collected with the unique Media Access Control (MAC) address of the subscriber's modem. The unique MAC address of the subscriber's modem is the modem's unique hardware number assigned to the cable modem by the manufacturer of the cable modem. When the subscriber is connected to the Internet, a corresponding table is used to correlate the subscriber's IP address to the cable modem's MAC address.

A data collection engine may be interfaced to the DOCSIS CMTS in the cable operator's network. Data collection activities by high-speed data system operators for marketing, research and management purposes are directed at gaining insight to the data usage patterns and behaviors of uniquely identifiable individuals. Once collected, the subscriber use data is tagged with the MAC address corresponding to the subscriber's IP address. Linking the collected data to the individual subscriber may present a privacy issue. Existing products that are designed to protect the identification of the individual subscriber are based on falsification of the subscriber's IP address. Conversion of the subscriber's MAC address requires a database to correlate the subscriber's MAC address to the falsified IP address. A second database still exists correlating the subscriber's IP address and the subscriber's cable modem MAC address. Since the MAC address corresponding to the actual IP address is not obscured, the MAC address may still be used to correlate the collected data use to the actual subscriber.

For these reasons, a need exists for a device that collects discrete subscriber use data while obscuring the identification of the actual subscriber.

### SOLUTION

The present anonymizer data collection device allows a network operator to protect a subscriber's identity as a part of a data collection effort. A network termination system allows the network operator to offer Internet access to network subscribers. The network between the subscriber's modem and the network termination system utilizes a network protocol to send and receive data between the subscriber's modem and the network termination system. The subscriber or subscriber's modem is identified on the network by a unique identifier. At the network termination system, the unique identifier is correlated to a corresponding IP address for interfacing the subscriber modem to the Internet. The unique identifier assigned to the subscriber or subscriber's modem is encrypted to generate an encrypted identifier used to tag the subscriber data use information. Encryption of the unique identifier allows collection of subscriber data use information while protecting the identity of the subscriber from which the data are collected. When a legitimate need arises, the identity of the subscriber can be recovered using the decryption algorithm, which is otherwise protected by the network provider.

### BRIEF DESCRIPTION OF THE DRAWINGS

FIG. 1 illustrates an example of a network interface to the Internet;

FIG. 2 illustrates an example of a DOCSIS CMTS in a cable operator's network embodying the present anonymizer data collection device; and

FIG. 3 illustrates a flow diagram of a method for protecting a subscriber's identity utilizing the present anonymizer data collection device.

### DETAILED DESCRIPTION

The present anonymizer data collection device summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

The present anonymizer collection device allows a network operator to collect subscriber data use information and tag the collected data use information with an encrypted identifier to protect the identity of the subscriber or the subscriber modem. The anonymizer data collection device may be embedded in a network such as dialup telephony, DSL, satellite, cable, and wireless networks. For purpose of illustration and not limitation, the present anonymizer collection device is described and illustrated for use by a cable operator in a cable network.

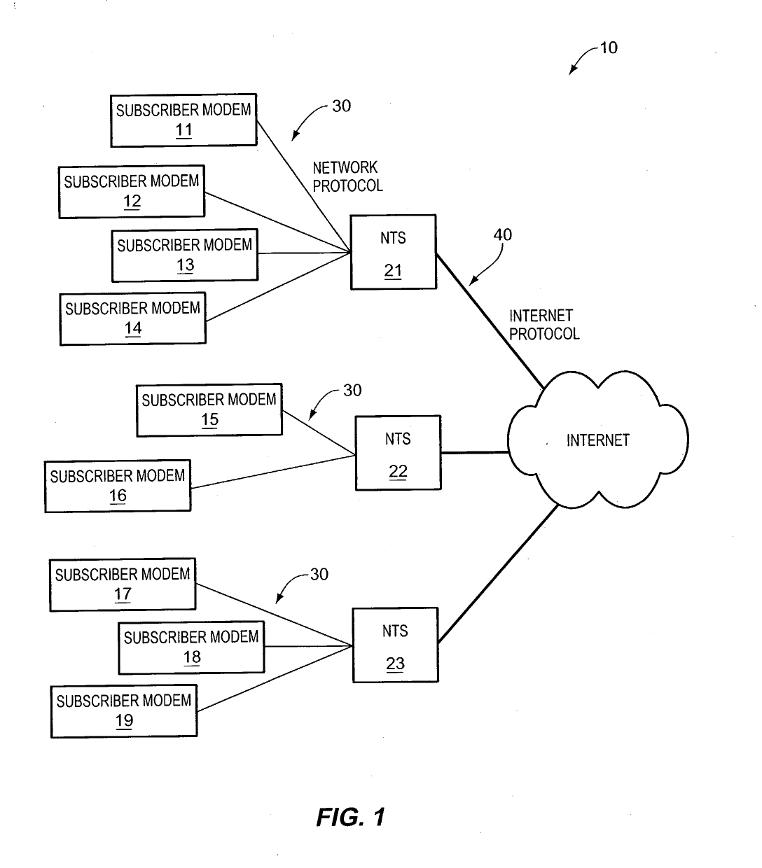

A network termination system allows network operators to offer high-speed Internet access to home computers. FIG. 1 illustrates an example of a network interface to the Internet. The NTSs 21-23 send and receive digital modem signals 30 on the network, receiving signals sent upstream from subscriber modems 11-19, converting the signals to Internet protocol 40 and routing the signals on to an Internet Service Provider (ISP) (not shown) for connection to the Internet. The NTS also sends signals downstream from the Internet to the subscriber's modem. Modems cannot communicate directly with each other; they must communicate by channeling their signals through the NTS.

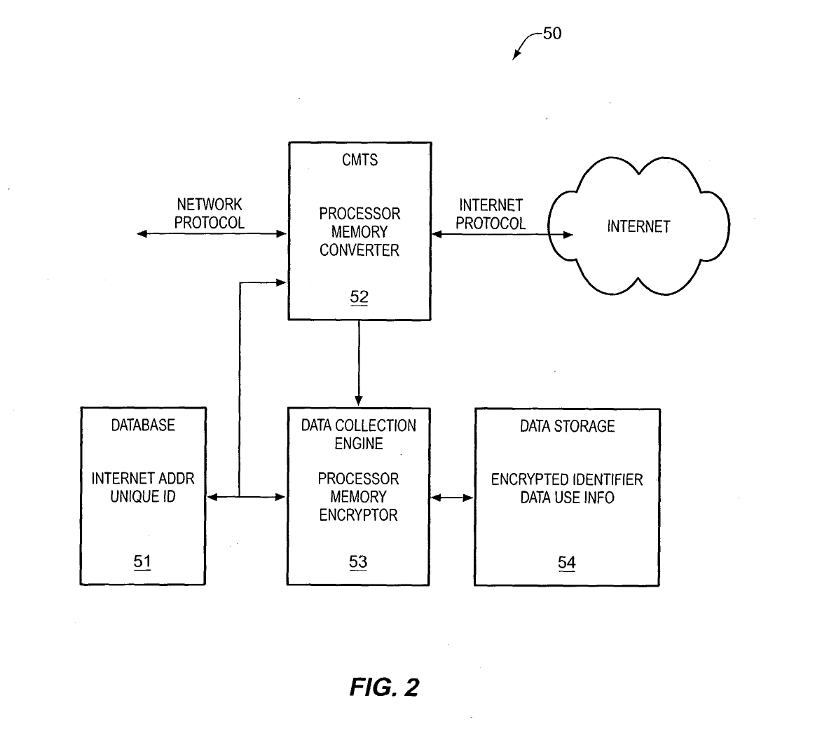

FIG. 2 illustrates the present anonymous data collection device embedded in a cable network having a cable modem termination system (CMTS). A CMTS is a network of termination system devices that allows cable operators to provide high-speed Internet access to cable subscribers. Data Over Cable Service Interface Specification (DOCSIS) is a standard interface for cable modems, the devices that handle incoming and outgoing data signals between the cable operator and a subscriber's personal or business computer or television set. DOCSIS specifies modulation schemes and the protocol for exchanging the bi-directional signals over cable. In other words, DOCSIS is the network protocol used for sending and receiving signals, between the subscriber cable modem and the CMTS where the signals are converted to/from DOCSIS from/to Internet protocol.

Referring to the CMTS of FIG. 2, a data collection engine 53 may be interfaced to the CMTS 52 in the cable operator's network. In a DOCSIS-based cable high-speed data system, data on individual subscriber's data use is collected by various means and uniquely identified by tagging the data collected with a unique identifier. The unique identifier of the cable modem in this example is the Media Access Control (MAC) address of the subscriber's cable modem. The MAC address of the subscriber's cable modem is the cable modem's unique hardware identifier. When the subscriber is connected to the Internet, a corresponding database 51 is used to correlate the subscriber's IP address to the cable modem's physical MAC address, the unique identifier in this example. The MAC address is used for routing data over the cable network while the IP address is used for routing data over the Internet. When the present anonymizer data collection device is installed in an alternative network, such as dialup telephony, DSL, satellite and wireless, an alternative unique identifier corresponding to the subscriber or subscriber equipment may be substituted for the MAC address.

The MAC address is a unique, constant value that is assigned to the cable modem by the manufacturer of the cable modem. The MAC address stored in the database 51 corresponds to the subscriber's stored IP address. Since the MAC address is a constant, the MAC address may be used to correlate the data collected with the actual subscriber. Conversion of the subscriber's IP address to a MAC address fails to obscure the subscriber's actual identity, thus the subscriber's data use information collected by data collection engine 53 and stored at data storage device 54 may be compiled and correlated directly to the actual subscriber from which the data are collected.

The present anonymizer data collection device includes a suitable encryption algorithm for encrypting the unique identifier, the subscriber MAC address in this example, to generate an encrypted identifier that cannot be decrypted without the secret or the secret key which is protected by the network operator. The data collected at data collection engine 53 is tagged with the encrypted identifier and stored at storage device 54. The data collected may be compiled for marketing, research, or management purposes that are directed at gaining insight into the data use patterns of behavior that do not require disclosure of the subscriber's actual identity. While use of the collected data use information may be primarily used by the network operator for network management, system planning or to determine the impact of new services, the network operator may turn the collected data use information over to a third party for analysis. Encryption of the unique identifier allows the network operator to shield the identification of the subscriber or subscriber modem from the third party. Anonymization of the collected data use information also allows the cable operator to use the collected data use information for anonymized marketing.

The cryptographic protocol used for encrypting the unique identifier may be a symmetric or asymmetric. Encrypting the unique identifier allows for the collection and compilation of subscriber usage information over the network in a manner that protects the subscriber's actual identity, thereby addressing subscriber privacy concerns. While the present anonymizer data collection device is illustrated and described for use encrypting the MAC address assigned to the subscriber cable modem, an alternative permanent unique identifier identifying the subscriber or the subscriber equipment may be substituted.

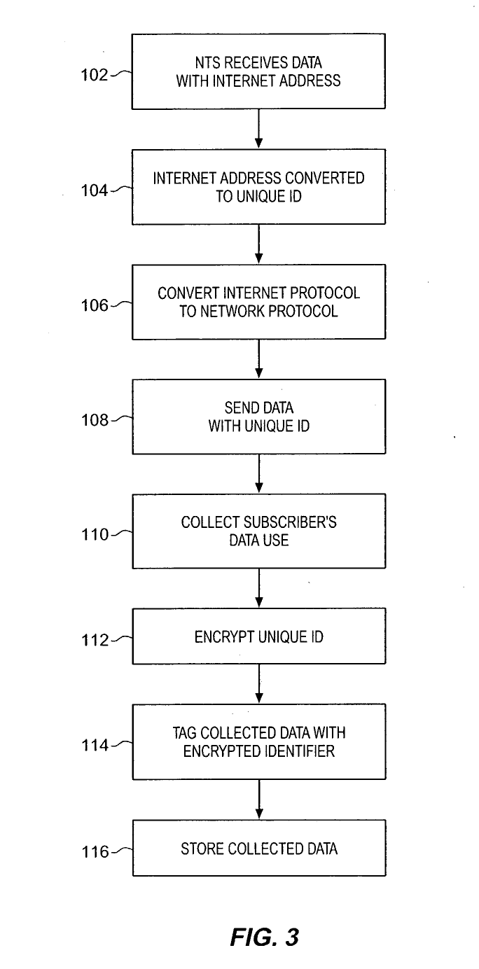

Referring to the cable network interface of FIG. 2 in conjunction with the flow diagram of FIG. 3, a network termination system, CMTS 52 in this example, receives data from the Internet in step 102. The received data includes an Internet address that identifies the actual subscriber for which the data is intended. Using a database 51 which correlates the IP address of the subscriber's connected to network 30 with the unique identifier, a MAC address in this example, of the subscriber's modem, the subscriber IP address is converted to a corresponding unique identifier in step 104. In step 108, the received data is converted from Internet protocol to network protocol, such as DOCSIS, for routing on the network. In step 108, the network termination system sends the data to the corresponding modem on network 30.

While the method is illustrated for receiving data from the Internet and sending the received data to the subscriber's modem, data is also sent from the subscriber modem to the network termination system using the modem's unique identifier. At the network termination system, the unique identifier is replaced with the corresponding IP address and the data is converted to Internet protocol for transmission over the Internet.

As data is sent from and received at the network termination system, a data collection engine 53 collects subscriber data use information. The data use information may include overall bandwidth usage, upstream and downstream bandwidth, time of day, information relating to the web sites visited, the usage of the website or other information of interest to the network operator. The collected information is valuable for compiling overall network usage and may provide insight into the data usage patterns and behaviors of subscribers. For example, subscriber data use information may be used by the network operator to develop a tiered payment plan wherein a subscriber with heavy data use would pay a higher rate than a subscriber having a lower data use. The tiered payment plan may not target actual subscribers, but may group subscriber usage into categories whereby the network operator offers a payment plan which is based on the subscriber's expected network usage. In this example, the actual subscriber's unique identifier is not required. The data collected is related to the subscriber's data usage patterns and not information related to subscriber transactions, and is therefore useful to the network operator for network management, system planning and for measuring the impact of new service offerings.

A network embodying the present anonymizer data collection device obscures the identity of the actual subscriber by encrypting the subscriber's unique identifier in step 112 to generate an encrypted identifier. In step 114, the collected data use information is tagged with the encrypted identifier to protect the identity of the individuals from which the data are collected. Once tagged with the encrypted identifier, the collected data is stored at a storage device 54. Since the encrypted identifier may be decrypted to recover the original unique identifier, there is not a need for a database to cross reference the encrypted identifier with the unique identifier used to generate the encrypted identifier.

Since the unique identifier is encrypted, it cannot be correlated with a specific individual without use of the appropriate decryption algorithm, and the decryption algorithm is protected by the network operator. However, should a legal or legitimate need arise, the identification of the subscriber could be recovered using the decryption algorithm. Thus, the present anonymizer data collection device collects discreet subscriber data in a way that obscures the actual identify of the subscriber. The present anonymizer data collection device provides a method for the network operator to protect the subscriber's identity as part of a data collection effort without the subscriber needing to install any specific application.

While the present anonymizer data collection device has been illustrated and described for use in a cable network, it may also be used by operators of other networks (dialup telephony, DSL, satellite and wireless) for collection of data for marketing and network management. As to alternative embodiments, those skilled in the art will appreciate that the present anonymizer data collection device may be implemented with alternative methods of obscuring the identity of the actual subscriber, such as encryption of a permanent unique address assigned to the subscriber or the subscriber equipment (e.g., an IP address) and tagging the collected data with the encrypted permanent address. The IP address assigned by the domain name server (DNS) may be dynamic. However, if an accurate record is maintained that indicates the dynamic IP address assigned to a subscriber or subscriber equipment at a particular time, the dynamic IP address may be used to generate an encrypted identifier.

It is apparent that there has been described an anonymizer data collection device that fully satisfies the objects, aims, and advantages set forth above. While the anonymizer data collection device has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

1. A data collection device for protecting an identity of a subscriber while collecting subscriber data use information on a communications network, said communications network including a subscriber termination device with an associated unique identifier, the device comprising:
a means for monitoring a data routed on said communications network;
a means for collecting said subscriber data use information relating to said data routed on said communications network;
a means for encrypting said unique identifier to produce an encrypted identifier; and
a means for tagging said collected subscriber data use information with said encrypted identifier to obscure said unique identifier associated with said subscriber termination device.

2. A cable anonymizer data collection device for collecting subscriber data use information as digital cable modem signals are transferred on a cable network between a subscriber cable modem with a unique MAC address and a cable modem termination system (CMTS) which interfaces said subscriber digital cable modem to the Internet, the data collection device comprising:
a means for monitoring said data routed on said cable network;
a means for collecting said subscriber data use information relating to said data routed on said cable network;
a means for encrypting said MAC address to produce an identifier; and
a means for tagging said collected subscriber data use information with said identifier to obscure the identity of a subscriber from which said data is collected.

3. A method for collecting subscriber data use information as data is transferred on a network between a subscriber modem with a unique identifier and a network termination system which interfaces said subscriber modem to the Internet, said subscriber modem having a unique network number which correlates to a subscriber IP address, the method comprising the steps of:
receiving said data at said network termination system;
converting a one of said network address and said IP address to the other one of said network address and said IP address for transmission of said data over a corresponding one of said network and the Internet;
encrypting said one of said network address and said subscriber IP address to produce an identifier;
collecting said subscriber data use information at said network termination system; and
tagging said collected subscriber data use information with said identifier to protect an identification of a subscriber from which said subscriber data use information was collected.

4. A method for anonymously collecting subscriber data use information as data are transferred on a cable network between a subscriber cable modem and a cable modem termination system (CMTS) which interfaces said subscriber cable modem to the Internet, the method comprising:
collecting said subscriber data use information while a subscriber is using said cable network;
associating a unique address and a unique MAC address corresponding to said subscriber cable modem;
encrypting said MAC address to produce an identifier;
tagging said collected subscriber data use information with said identifier; and
storing said tagged subscriber data use information.
